(19) United States
(12) Patent Application Publication
(10) Pub. No.: US 2008/0102329 A1
(43) Pub. Date: May 1, 2008

(54) Material neutral power generation

(76) Inventor: Ted Hollinger, Algona, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 11/973,552

(22) Filed: Oct. 9, 2007

Related U.S. Application Data
(60) Provisional application No. 60/850,574, filed on Oct. 10, 2006.

(51) Int. Cl. H01M 8/04

(52) U.S. Cl. 429/17

(57) ABSTRACT

A renewable electrical power generation system is provided having energy storage and a power generation system to convert the stored energy to electrical power to ensure the end user with a continuous source of electrical power. The system comprises a renewable energy to electrical power unit plus a system to convert electricity to fuel (hydrogen and/or ammonia) with the required associated fuel storage and a fuel to electricity unit (engine and generator and/or fuel cell). This system has a monitor and control system that ensures proper operation such that the end user receives electrical power in the most efficient way.

### BACKGROUND OF THE INVENTION

The present invention relates to the generation of power from a renewable source, particularly an intermittent source such as wind or solar, in a manner that has energy storage that allows the user an unlimited time of use. More specifically, the invention comprises a renewable electrical power source, an electrolyzer to convert the electricity to hydrogen, a storage unit to hold the hydrogen, an electric power generation unit that converts the hydrogen to electricity, such as an internal combustion engine and associated generator or a fuel cell and associated electronics, and a control system to monitor and control the process.

Renewable power generation systems are generally intermittent power sources because the energy source, such as wind or solar, are not continuous. This lack of continuous power availability creates a “time of use” problem for the end user. The solution to this problem is to store the renewable energy for use at any desired time. Various methods have been tried, including storage batteries, but none have proved to be competitive and/or pollution free. An advantage of storing renewable, intermittent power is that end users could be freed from other sources of electricity, such as the electrical power grid. A second advantage is that the stored power could be used at a location that is remote from where the renewable, intermittent energy is generated. For example, one of the best onshore wind sites in the world is in Patagonia, Argentina. Unfortunately, this is not near any of the world's population centers. Transporting the energy then becomes a problem. This problem is made worse if there are air quality concerns with the generation and/or the transportation of the energy. A clean solution is needed.

The basic configuration of a renewable, time-independent wind system would be a windmill or wind turbine that could provide power directly to the end user and/or could provide power to an electrolyzer that can convert electricity into hydrogen by splitting water into oxygen and hydrogen. This hydrogen can then be stored for use at a later time. When electrical power beyond what the windmill can provide is needed, the stored hydrogen is used as fuel for a genset or fuel cell. The genset comprises an internal combustion motor linked to a generator. Power is transferred from the engine to the generator for the purpose of generating electricity. The exhaust from the internal combustion engine contains nitrogen, unused oxygen from the air, and water vapor. The water vapor is condensed to recover the water and that water can then be sent back to the electrolyzer to start the process all over again. The internal combustion engine or fuel cell gets its fuel from the electrolyzer in the form of hydrogen and combines this with oxygen from the air. Note that the oxygen from the electrolyzer can also be used by the internal combustion engine and/or fuel cell. It is not typically common to store oxygen, so it will most likely not be used directly, but instead released to the air. The amount of this oxygen released to the air from the electrolyzer will be identical to the amount of oxygen that will be used by the internal combustion engine whether taken from the air or from the electrolyzer. The process can be summarized in that the electricity from the renewable energy conversion unit is used to split water (H₂O) into hydrogen and oxygen. The oxygen is released into the air and the hydrogen is stored as a fuel. When the fuel is used, the internal combustion engine and/or fuel cell takes oxygen from the air and combines it with hydrogen and generates both electrical power and water. Any excess oxygen is returned to the air so that the environment surrounding the total system is not affected by the system. Electricity from the renewable source comes into the system and eventually (at a different time) goes back out as electricity and nothing in the surrounding ecosystem is affected.

Frequently, the renewable electrical power system is connected to the electrical power grid. In these cases the grid serves as the storage media. In the case of wind, providing the grid with power late at night or very early in the morning is of little use since the grid can not really store energy, but can only route it to ready users of which there are few during these hours. In this situation the wind energy would better serve the customer if it could be stored and then delivered when needed. When used in this manner, the load on the grid interconnect system can be reduced. This would be critical during brown out or overload conditions.

In some cases portions of the population are isolated from the grid and their electrical power is supplied that the use of diesel fueled electrical generators. The use of diesel fuel to make electrical power is costly, both because of transportation and in terms of air pollution. A better solution is to use a windmill and store part of the energy for use at a later time. In this manner there is not any fuel transportation cost and there is no air pollution.

A more complex version of a material neutral process involves the conversion of the hydrogen fuel to ammonia before storing it. In this method the hydrogen is converted to ammonia thru a process such as the Haber-Bosch process. This process takes nitrogen from the air and combines it with hydrogen to produce ammonia. The ammonia is then used as fuel for an internal combustion engine powered electrical generator. The internal combustion engine will combust the hydrogen portion of the ammonia, converting it to water vapor, and then release the nitrogen portion back to the air. In this manner, the nitrogen that was used to produce the ammonia is released back into the air. As with the previously described process the ammonia storage system does not disturb the environment surrounding the total system.

### SUMMARY OF THE INVENTION

The present invention intends to overcome the difficulties encountered heretofore. To that end, a renewable energy system is provided having a design that uses molecules in the storage and generation of electrical power in such a way that all of the molecules are in the same balance with the environment as they were before and after use. In other words nothing is taken from the environment and noting is added to the environment. Electricity goes into the system, is converted to a fuel that can be stored and/or transported, and then the fuel is converted back into electricity at another time and/or place. The system thus is a conduit of energy from one time to another time and/or from one place to another place.

An object of the present invention is to provide a improved apparatus and method for converting and storing energy without disturbing or polluting the environment surrounding the apparatus.

These and other objects of the present invention will become apparent to those skilled in the art upon reference to the following specification, drawings, and claims.

### BRIEF DESCRIPTION OF THE DRAWINGS

FIG. 1 is a diagram of a material neutral system with hydrogen used as the energy storage media; the power source is either an internal combustion engine or a fuel cell based electrical power generator.

FIG. 2 is a diagram of a material neutral system with ammonia used as the energy storage media. This unit includes a Haber-Bosch unit that converts hydrogen to ammonia; the power source is an internal combustion engine or a fuel cell based electrical power generator.

### DETAILED DESCRIPTION OF THE INVENTION

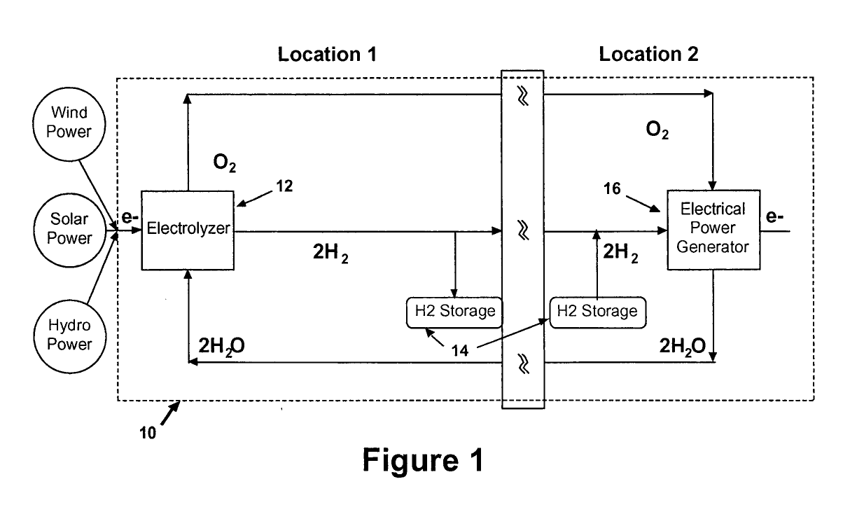

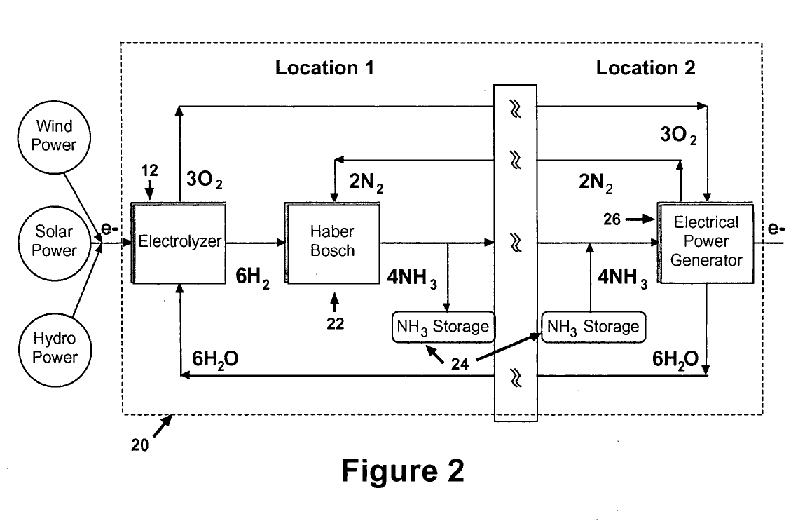

FIGS. 1 and 2 are schematic block diagrams of material neutral processes for generation of power. Each process begins with a renewable energy source such as wind, solar, geothermal or hydropower. This energy source is used to provide power to an electrolyzer for hydrogen separation. The electrolyzer separates hydrogen from oxygen by applying an electrical current to water. Thus, the inputs to the electrolyzer are electrical power and water. The outputs are hydrogen and oxygen.

In FIG. 2, the hydrogen from the electrolyzer is then combined with nitrogen to synthesize ammonia using conventional Haber-Bosch processing. The Haber-Bosch process reacts nitrogen and hydrogen to produce ammonia under very high pressure and moderately high temperatures. The process typically uses a catalyst made from iron in order to carryout the process at a lower temperature than is otherwise possible.

The resulting ammonia is then stored conventionally for delivery as fuel to a power source. Preferably, the power source comprises an internal combustion engine configured to burn ammonia. The resultant power can then be used for a variety of purposes, including electrical generation.

Preferably, the ammonia is combined with oxygen to enhance combustion, wherein the oxygen is provided at least in part from the electrolyzer. Two by-products of the combustion process are water and N₂, both of which can be recycled within the process. Six molecules of water are returned to the electrolyzer for further hydrogen production, and the N₂ is returned for production of ammonia.

In FIG. 1, a material neutral power generator system 10 is shown. The system is comprised of an electrolyzer 12, a fuel storage system 14, and an electrical power generator 16 located therebetween. The power source for 16, preferably, is an internal combustion engine, but could be a fuel cell. However, those of ordinary skill in the art will understand that the invention is not so limited. The present invention can be adapted to any combination of system components that can achieve the same basic function.

FIG. 2 shows a material neutral power generator system 20. The system is comprised of an electrolyzer 12, a Haber-Bosch unit 22, a fuel storage system 24, and an electrical power generator 26 located therebetween. The power source for 16 is an internal combustion engine. However, those of ordinary skill in the art will understand that the invention is not so limited. The present invention can be adapted to any combination of system components that can achieve the same basic function.

The electrolyzer unit 12 in each figure takes in electricity in the form of electrons (e−) and water (H₂O) and outputs hydrogen (H₂) and oxygen (O₂). The oxygen is released to the air and the hydrogen is stored is a suitable receptacle 14 or passed on to the Haber-Bosch unit 22 (FIG. 2). In the later case, the Haber-Bosch unit 22 takes nitrogen (N₂) from the air and combines it with hydrogen to produce ammonia (NH₃). The ammonia is stored in a suitable receptacle 24 for further use. The fuel from the storage receptacle 14 or 24 is then used by the electrical power generator 16 or 26 to produce electricity in the form of electrons (e−). The electrical power generator takes in oxygen from the air in both cases. Electrical power generator 26 also takes in nitrogen as part of the ammonia fuel and releases nitrogen back into the air. In this manner, the Haber-Bosch unit 22 takes the nitrogen released into the air by the electrical power generator 26 and uses it to make more ammonia.

The material flow for FIG. 1 (excluding electrons) starts with two molecules of water, 2H₂O, going into the electrolyzer 12. The electrolyzer then splits the water into two output gases; hydrogen (2H₂) and oxygen (O₂). The oxygen (O₂) is released into the air for further use while the hydrogen (2H₂) is stored as a fuel for the electrical power generator. The electrical power generator takes in hydrogen (2H₂) and oxygen (O₂) and outputs two molecules of water (2H₂O). It is obvious then that the amount of output gases from the electrolyzer exactly matches the requirements for the input gases for the electrical power generator. In addition the output of the electrical power generator is two molecules of water (2H₂O) which exactly matches the input requirements of the electrolyzer, thus nothing is added or subtracted from the surrounding eco-system.

The material flow for FIG. 2 (excluding electrons) starts with six molecules of water (6H₂O) going into the electrolyzer 12. The electrolyzer then splits the six molecules of water (6H₂O) into two output gases; six molecules of hydrogen (6H₂) and three molecules of oxygen (3O₂). The three molecules of oxygen (3O₂) are released into the air for further use while the six molecules of hydrogen (6H₂) are used to make ammonia through the Haber-Bosch process, which is stored as a fuel electrical power generation. The Haber-Bosch unit takes in two nitrogen molecules (2N₂) from the air along with six molecules of hydrogen (6H₂) and outputs four ammonia molecules (4NH₃). The electrical power generator takes in four ammonia molecules (4NH₃) and three molecules of oxygen (3O₂) and outputs six molecules of water (6H₂O) and two nitrogen molecules (2N₂). The water is returned to the electrolyzer. It is obvious then that the amount of output gases from the electrolyzer and Haber-Bosch unit exactly match the requirements for the input gases for the electrical power generator. In addition the output of the electrical power generator is six molecules of water (6H₂O) and two molecules of nitrogen (2N₂) which exactly match the input requirements of the electrolyzer and Haber-Bosch unit, thus nothing is added or subtracted from the surrounding eco-system.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A method of improving the use of energy from a renewable source, comprising the steps of:
(a) generating electricity from a renewable source;
(b) using the electricity to electrolyze water into hydrogen and oxygen;
(c) storing the hydrogen for a desired length of time; and
(d) converting the hydrogen to electricity.

2. The method of claim 1, wherein the renewable energy source is selected from the group consisting of wind, solar, hydropower, and geothermal.

3. The method of claim 1, wherein the hydrogen is converted to electricity in an internal combustion engine that operates an electrical generator.

4. The method of claim 1, wherein the hydrogen is converted to electricity in a fuel cell.

5. A method of improving the use of energy from a renewable source, comprising the steps of:
(a) generating electricity from a renewable source;
(b) using the electricity to electrolyze water into hydrogen and oxygen;
(c) converting the hydrogen into ammonia;
(d) storing the ammonia for a desired length of time; and
(e) converting the ammonia to electricity.

6. The method of claim 5, wherein the renewable energy source is selected from the group consisting of wind, solar, hydropower, and geothermal.

7. The method of claim 5, wherein the ammonia is converted to electricity in an internal combustion engine that operates an electrical generator.

8. The method of claim 5, wherein the hydrogen is converted to electricity in a fuel cell.

9. The method of claim 1, further comprising the step of transporting the hydrogen prior to the conversion to electricity step.

10. The method of claim 5, further comprising the step of transporting the ammonia prior to the conversion to electricity step.
